(19) United States
(12) Patent Application Publication
(10) Pub. No.: US 2022/0391896 A1
(43) Pub. Date: Dec. 8, 2022

(54) HOSTED POINT-OF-SALE SERVICE

(71) Applicant: American Express Travel Related Services Company, Inc., New York, NY (US)

(72) Inventors: Andrew Lei, Brooklyn, NY (US); Manik Biswas, Burgess Hill (GB)

(21) Appl. No.: 17/337,291

(22) Filed: Jun. 2, 2021

(51) Int. Cl. G06Q 20/38; G06Q 20/40; G06Q 20/32

(52) U.S. Cl. CPC G06Q 20/3829; G06Q 20/401; G06Q 20/3276; G06Q 20/40145

(57) ABSTRACT

Disclosed are various embodiments for a hosted point-of-sale service that provides the security features of card-present transactions for card-not-present transactions. The various embodiments of the present disclosure can be configured to receive a merchant identifier and a transaction amount for a transaction from a merchant terminal, as well as receive the merchant identifier and encrypted payment account data for the transaction. The encrypted payment account data can then be decrypted. An authorization request for the transaction is then generated based at least in part on the merchant identifier, the transaction amount, and the payment account data. The authorization request is then sent to a payment processor, which can route the authorization request to an authorizing entity via a payment network. An authorization response is received in response from the authorizing entity via the payment processor, and the contents are forwarded on to the merchant terminal.

### BACKGROUND

Smart cards have been used extensively to reduce the incidence of fraudulent transactions when a payment card is used. For example, smart cards, such as credit, charge, or debit cards that comply with the Europay, Mastercard, and Visa (EMV) standard include a chip that can authenticate the card with an issuer, payment processor, or payment network. This allows for the card to be distinguished from unauthorized counterfeits or clones. When combined with a second authentication factor, such as a personal identification number (PIN), the EMV card can also authenticate that individual making a purchase with the EMV card is an authorized user or owner of the card.

Unfortunately, the additional security benefits of smart cards, such as EMV compliant credit, charge, or debit cards, do not apply to transactions where the card is not present for payment. Examples of card-not-present transactions include payments made over the telephone or the Internet using a credit, charge, or debit card. Accordingly, someone could use a stolen, forged, or counterfeit card that contains a valid credit card number to make a purchase over the phone or the Internet in order to by-pass the security safeguards that EMV compliant credit, charge, or debit cards provide to transactions where the card is present and authenticated with a payment terminal or point-of-sale (PoS) device.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing depicting an example use of one of several embodiments of the present disclosure to make a purchase on a website displayed on by a browser executing on a computing device.

FIG. 1B is a drawing depicting an example use of one several embodiments of the present disclosure to make a purchase at a retail location while interacting with a physical payment terminal.

FIGS. 2A-2D are a series of drawings depicting an example use of one several embodiments of the present disclosure to make a purchase through a website displayed by a browser executing on a mobile device.

FIG. 3 is a drawing of a network environment according to various embodiments of the present disclosure.

FIG. 4 is a sequence diagram illustrating one example series of interactions between the components of the network environment of FIG. 3.

FIG. 5 is a sequence diagram illustrating a second example series of interactions between the components of the network environment of FIG. 3.

FIG. 6 is a flowchart illustrating one example of functionality implemented as portions of an application executed in a computing environment in the network environment of FIG. 3 according to various embodiments of the present disclosure.

FIG. 7 is a flowchart illustrating one example of functionality implemented as portions of an application executed in a computing environment in the network environment of FIG. 3 according to various embodiments of the present disclosure.

### DETAILED DESCRIPTION

Disclosed are various approaches for providing a hosted point-of-sale service to merchant terminals or payment platforms. A merchant can provide transaction information to a cloud-based payment terminal that provides point-of-sale services. Payment information can subsequently be securely collected from an authenticated or authorized user and forwarded on to the cloud-based payment terminal that provides point-of-sale services. The cloud-based payment terminal can then generate an authorization request for the transaction using the payment information provided by authorized user and the transaction information provided by the merchant terminal. Because the cloud-based payment terminal has or will acquire the same information that a physical point-of-sale terminal would have or would acquire in a card-present transaction, the cloud-based payment terminal is able to generate an authorization request on behalf of the merchant as if the cloud-based payment terminal were participating in a card-present transaction. As a result, the cloud-based payment terminal offered by the hosted point-of-sale service is able to provide the additional security features used in card-present transactions to minimize fraud (e.g., cryptographic validation of the debit, credit, or charge card) to merchants that typically rely on card-not-present transactions for payment (e.g., purchases made through a website or over the telephone). This improves the security of card-not-present transactions by allowing merchants to utilize the additional cryptographic security features that are available for card-present transactions.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

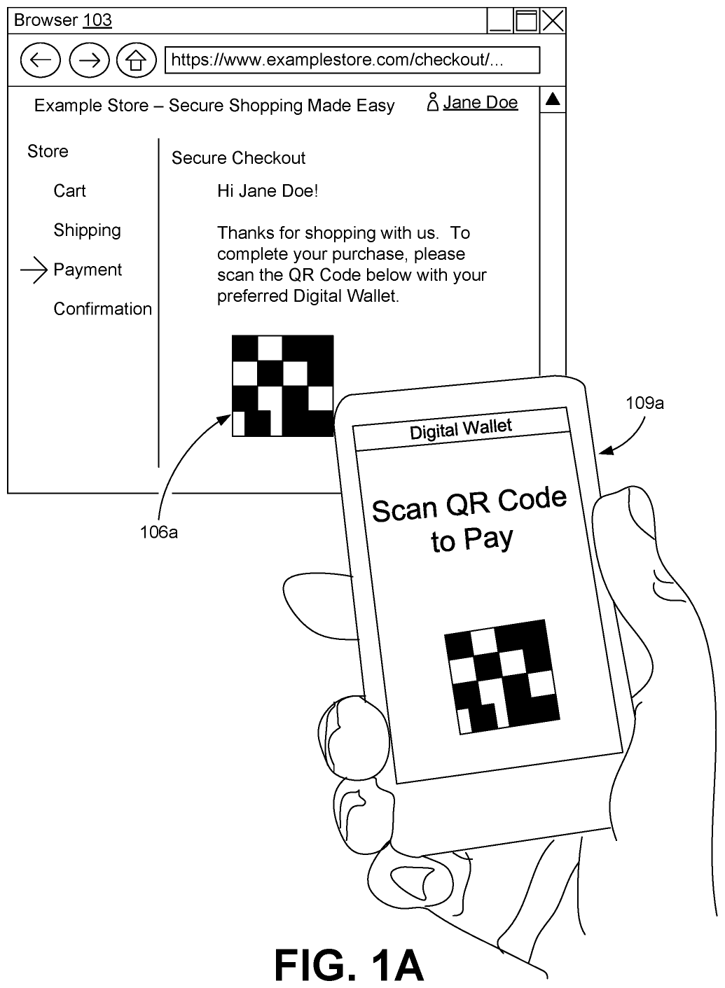

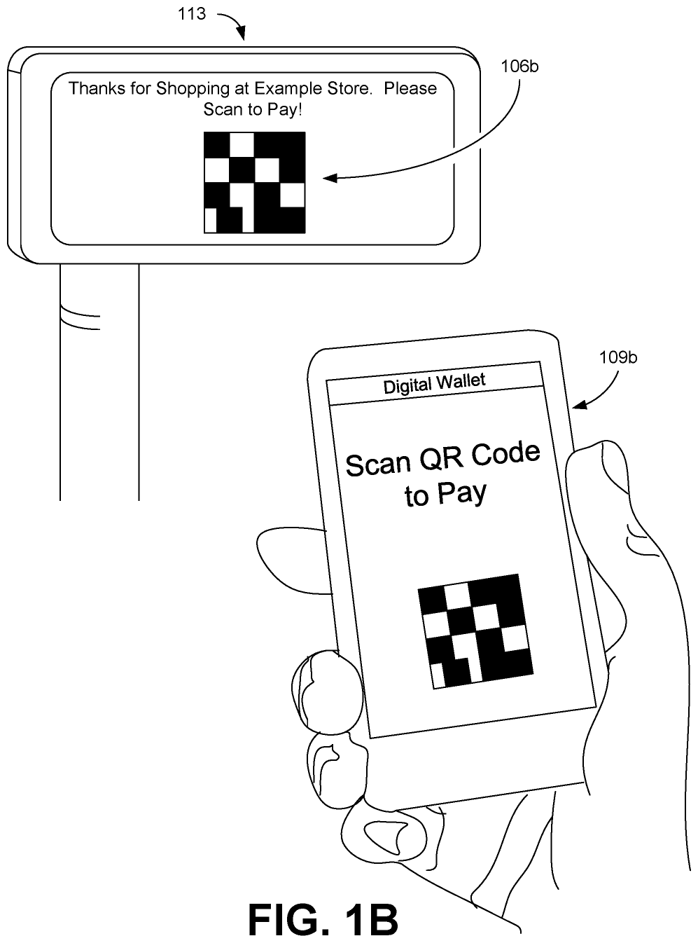

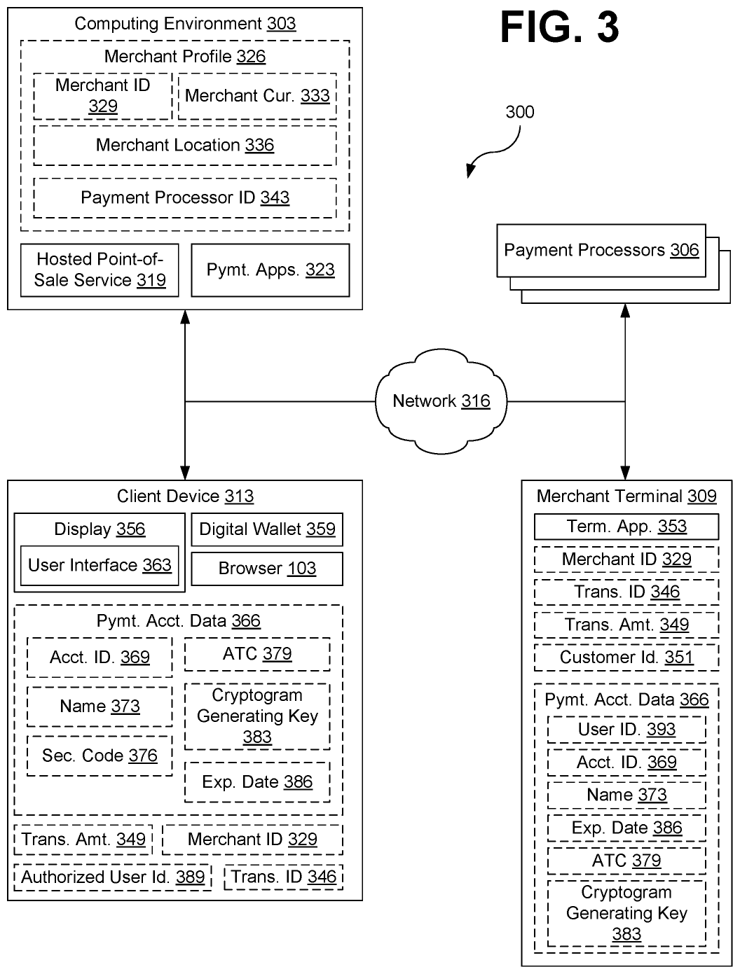

FIG. 1A illustrates one example of a user experience with various embodiments of the present disclosure, as further described in FIGS. 3-7. Here, a user could be shopping on a website using a browser 103 executing on his or her personal computer (e.g., a desktop, laptop, tablet, etc.). After finishing shopping, the user could begin the checkout process, whereby the user confirms the items to be purchased, provides shipping and billing information, tenders payment to the merchant, and receives a confirmation of the order once the payment is approved.

As part of the payment process, the merchant could cause a matrix bar code 106a (e.g., a quick response (QR) code, an Aztec Code, a PDF417 code, a Data Matrix code, etc.) to be displayed or rendered within the webpage. The matrix bar code 106a could include various information about the transaction, such as the amount of the transaction, the identity of the merchant, and a transaction identifier. The user could then use his or her mobile device 109a to scan the matrix bar code 106a with his or her preferred payment application or digital wallet. Upon scanning the matrix bar code 106a, the payment application or digital wallet executing on the mobile device 109a could then send payment information to a hosted point of sale service to complete the transaction.

Upon receiving the payment information from the mobile device 109a, the hosted point of sale service could then request the transaction to be authorized as if user had physically presented his or her payment card to the merchant operating the website. This could include generating the appropriate cryptograms to authorize the transaction, as described in later paragraphs. As a result, the merchant and the user are able to engage in a card-not-present transaction, yet benefit from the additional security provided for transactions where the payment card is physically presented to a merchant.

FIG. 1B illustrates a similar example, where a user is shopping in a retail store, as further described in FIGS. 3-7. After finishing shopping, the user could checkout and attempt to pay the merchant. As part of the checkout process, the user could be prompted to scan a matric bar code 106b with his or her mobile device 109b. The matrix bar code 106b could be displayed on screen of a physical payment terminal 113. The matrix bar code 106b could include various information about the transaction, such as the amount of the transaction, the identity of the merchant, and a transaction identifier. The user could then use his or her mobile device 109b to scan the matrix bar code 106b with his or her preferred payment application or digital wallet. Upon scanning the matrix bar code 106b, the payment application or digital wallet executing on the mobile device 109b could then send payment information to a hosted point of sale service to complete the transaction.

Upon receiving the payment information from the mobile device 109b, the hosted point of sale service could then request the transaction to be authorized as if user had physically presented his or her payment card to the merchant operating the physical payment terminal 113. This could include generating the appropriate cryptograms to authorize the transaction, as described in later paragraphs. As a result, the merchant and the user are able to engage in a card-not-present transaction, yet benefit from the additional security provided for transactions where the payment card is physically presented to a merchant.

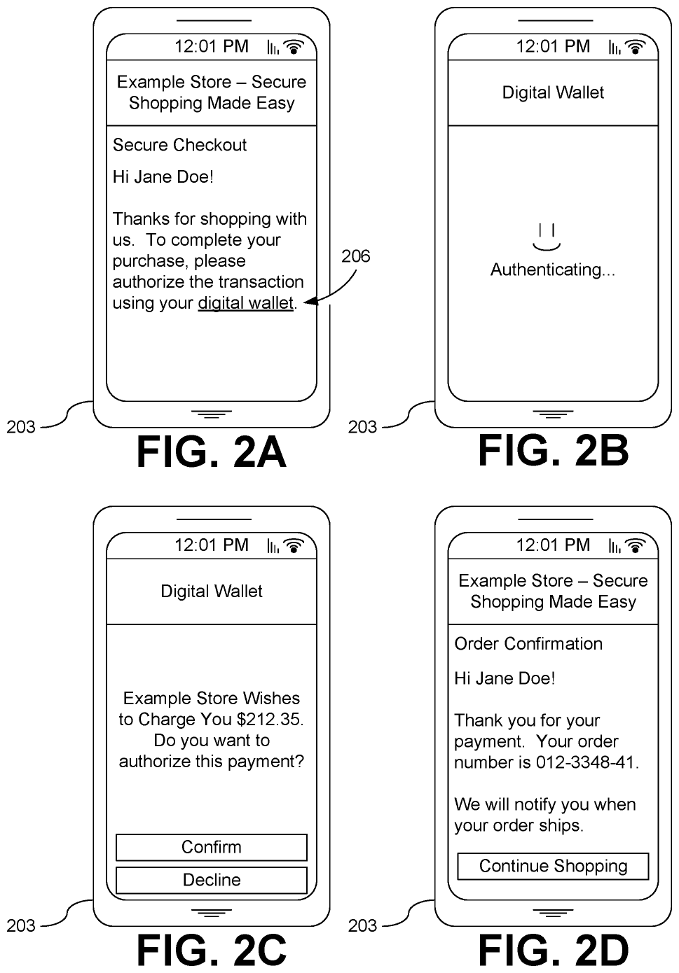

FIGS. 2A-2D illustrate another example of a user experience with various embodiments of the present disclosure, which are further described in FIGS. 3-7. Here, a user could be shopping on his or her mobile device 203 (e.g., smartphone, tablet, etc.) using a mobile-optimized web page displayed by a browser or a dedicated application installed on the mobile device 203. As part of the checkout process, the merchant can request payment. The browser or merchant application could then cause a payment application or digital wallet installed on the mobile device 203 to open, so that the user could approve or authorize payment in order to complete the transaction with the merchant.

For example, FIG. 2A depicts how the user could be prompted during the checkout process to provide payment. The prompt could include a uniform resource locator (URL) 206 provided by the merchant and rendered for display by the mobile device 203. The URL 206 could, when manipulated, cause the mobile device 203 to open a payment application or digital wallet installed on the mobile device 203. Accordingly, the URL 206 could encode information such as the name or identity of the payment application or digital wallet, as well other information such as the identity of the merchant, the amount of the transaction, an identifier for the transaction, etc.

As a result, at FIG. 2B, the mobile device 203 the mobile device 203 can open or launch the payment application or digital wallet specified by the URL 206. In some implementations, the payment application or digital wallet can be configured to authenticate the user of the mobile device 203 when launched. This could be done using biometrics (e.g., facial recognition, fingerprint scanning, etc.), prompting the user for a password, etc.

Then, at FIG. 2C, the payment application or digital wallet can present the transaction information to the user for confirmation or authorization. As shown, the payment application or digital wallet can identify the merchant that is requesting payment and the amount of the payment. One or more user interface elements 209a and 209b (collectively “user interface elements 209) can be displayed to the user to allow the user to authorize or decline the transaction. As previously discussed and illustrated, this can be done in response to a previous authentication of the user, so that the identify of the user authorizing the transaction is verified.

In response to the user authorizing the transaction, the payment application or digital wallet executing on the mobile device 203 could then send payment information to a hosted point of sale service to complete the transaction. Upon receiving the payment information from the mobile device 203, the hosted point of sale service could then request the transaction to be authorized as if user had physically presented his or her payment card to the merchant operating the website. This could include generating the appropriate cryptograms to authorize the transaction, as described in later paragraphs. As a result, the merchant and the user are able to engage in a card-not-present transaction, yet benefit from the additional security provided for transactions where the payment card is physically presented to a merchant.

Assuming that the user authorizes the transaction, then the payment application or digital wallet could redirect the user back to the browser displaying the merchant's website or the merchant's application, as illustrated in at FIG. 2D. For example, after the user authorizes payment, the payment application or mobile application could return the user to the browser or the merchant application. Once the merchant receives a confirmation message from its payment processor that payment was authorized, then the merchant could display a confirmation in the browser or in its application, as illustrated in FIG. 2D.

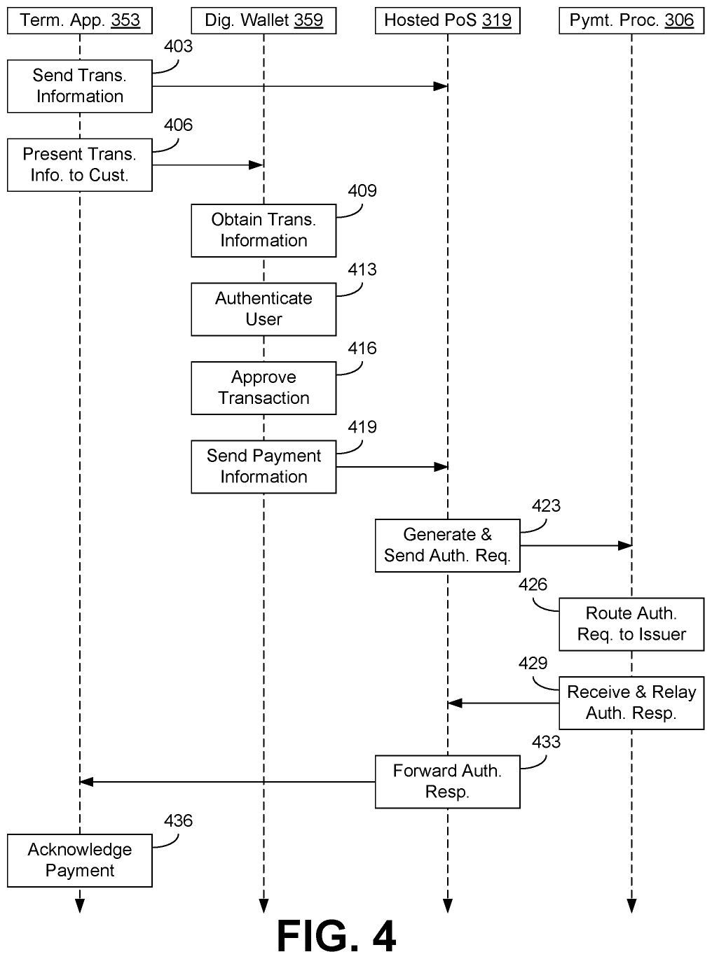

With reference to FIG. 3, shown is a network environment 300 according to various embodiments, such as those depicted in FIGS. 1A, 1B, and 2A-2D as well as those further described in subsequent FIGS. 4-7. The network environment 300 can include a computing environment 303, one or more payment processors 306, a merchant terminal 309, and a client device 313. Each of these can be in data communication with each other via a network 316.

The network 316 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 316 can also include a combination of two or more networks 316. Examples of networks 316 can include the Internet, intranets, extranets, virtual private networks (VPNs), and similar networks.

The computing environment 303 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 303 can employ a plurality of computing devices that can be arranged in one or more server banks or computer banks or other arrangements. Such computing devices can be located in a single installation or can be distributed among many different geographical locations. For example, the computing environment 303 can include a plurality of computing devices that together can include a hosted computing resource, a grid computing resource or any other distributed computing arrangement. In some cases, the computing environment 303 can correspond to an elastic computing resource where the allotted capacity of processing, network, storage, or other computing-related resources can vary over time.

Various applications or other functionality can be executed in the computing environment 303. For example, the computing environment 303 could implement or execute a hosted point-of-sale service 319, one or more payment applications 323, as potentially other network available services or applications. The computing environment 303 can also store one or more merchant profiles 326, which can be stored in secure database or data store accessible to the hosted point-of-sale service 319.

A merchant profile 326 can represent a merchant that uses the hosted point-of-sale service 319 to process payment transactions. Accordingly, the merchant profile 326 can include information used by the hosted point-of-sale service 319 to request authorizations of transactions between the merchant and a customer. This data can include a merchant identifier 329, a transaction currency 333, a merchant location 336, a payment processor identifier 343, and potentially other information as can be specified by current or future versions of the EMV standard or similar payment card standards.

The merchant identifier 329 can be any identifier that uniquely identifies a merchant registered to use the hosted point-of-sale service 319 with respect to other registered merchants. For example, the merchant identifier 329 could be sequentially or randomly assigned number, a globally unique identifier (GUID), a universally unique identifier (UUID), or similar identifier. The merchant identifier 329 can be generated and assigned to a merchant when the merchant registers to use the hosted point-of-sale service 319, which causes a merchant profile 326 to be created on behalf of the merchant.

The transaction currency 333 can represent the monetary currency that the merchant uses for transactions and in which the merchant expects to receive payment. For example, the transaction currency 333 could be United States Dollars (USDs) for a merchant located in the United States or other jurisdiction that has its currency pegged to the United States Dollar. Meanwhile, merchants located in other jurisdictions can have their transaction currency 333 specified as the local currency (e.g., Pound Sterling for United Kingdom merchants, Euro Dollars for European merchants, Yuan or Renminbi for Chinese merchants, Yen for Japanese merchants, Singapore Dollars for Singapore merchants, Won for South Korean merchants, etc.).

The merchant location 336 can represent a geographic location or address associated with the merchant. The merchant location 336 can be provided by the merchant when the merchant registers to use the hosted point-of-sale service 319. In some instances, merchant location 336 could be the address where the merchant terminal 309 is physically located (e.g., a retail store). In other instances, such as merchants that conduct business primarily or exclusively using card-not-present transactions, the merchant location 336 could be the address of the merchant or the address of the office(s) of the merchant. The merchant location 336 could also be more general, such as the country code representing the country in which the merchant is located.

The payment processor identifier 343 is a unique identifier that uniquely identifies a payment processor 306 with respect to other payment processors 306 supported by the hosted point-of-sale service 319. A payment processor identifier 343 can be included in the merchant profile 326 to identity the payment processor 306 used by the merchant to process payment card transactions (e.g., debit, charge, or credit card transactions). Although payment processor identifiers 343 can be created by the hosted point-of-sale service 319 in some implementations, other implementations can use a payment processor identifier 343 provided by the payment processor 306 itself.

The hosted point-of-sale service 319 represents a cloud-based payment terminal that provides point-of-sale services to merchants. Accordingly, the hosted point-of-sale service 319 can be executed to initiate payment transactions with a payment processor 306 on behalf of a merchant. As described in greater detail in subsequent paragraphs, the hosted point-of-sale service 319 can be executed to implement the functionality provided by physical point-of-sale terminals used by retailers. As a result, merchant terminals 309 can be configured to send payment information to the hosted point-of-sale service 319, thereby causing the hosted point-of-sale service 319 to generate the authorization request for a transaction and provide the authorization request to the payment processor 306 of the merchant. As another result, merchants can send payment information received as part of a card-not-present transaction to the hosted point-of-sale service 319, and the hosted point-of-sale service 319 can then generate an authorization request that includes the security features of a card-present transaction, as described in later paragraphs.

The payment application 323 can be executed to perform the functions defined by a payment network to generate an authorization request for a transaction that complies with the policies of the payment network. Each payment network can provide its own payment application 323, which can be used to generate an authorization request that complies with the policies of the payment network. As a simple example, VISA® can provide a payment application 323 for use in authorizing transactions with issuers that participate in the VISA payment network. Meanwhile, MASTERCARD® can have different policies and priorities than VISA, and therefore MASTERCARD can provide a separate payment application 323 for use in authorizing transactions with issuers that participate in the MASTERCARD payment network.

Payment networks are systems used to settle financial transactions through the transfer of monetary value. In the context of debit, charge, and credit card transactions, a payment network allows for issues of debit, charge or credit cards to communicate with payment processors 306 for the purpose of approving or rejecting transactions and transferring funds between an issuer and the merchant represented by the payment processor 306. For example, when a payment processor 306 sends an authorization request for a transaction to a payment network, the payment network will route the authorization request to the appropriate issuer (e.g., a bank), who can approve or reject the transactions specified in the authorization request. Once the issuer makes a decision regarding whether to approve or reject the transaction, the issuer can provide the decision to the payment network, which returns the decision to the payment processor 306. The payment processor 306 can then return the authorization decision to the point-of-sale terminal, service, or device.

The payment processor 306 represents one or more systems controlled by a payment processing entity to handle payment transactions on behalf of a merchant. The payment processor 306 accordingly can be configured to receive transaction authorization requests from a merchant, route the transaction authorization requests to the appropriate authorizing entities (e.g., the issuer of a payment card account such as a debit, credit, or charge card), and relay the authorization response or decision back to the merchant.

The merchant terminal 309 can represent a physical or virtual (e.g., software) device that allows a merchant to exchange payment information or transaction information with a customer or customer device, such as the client device 313. For example, a merchant terminal 309 could be a physical device that contains a display screen or a wireless transmitter such as a near field communications (NFC) transmitter, BLUETOOTH®, ultrawideband transmitter, etc. The display could render transaction information, such as the merchant identifier 329, transaction identifier 346, transaction amount 349, etc. This information could be presented in the form of a matrix bar code 106 or other format that is easily recognized by a client device 313. Additionally or alternatively, the merchant terminal 309 could also include a wireless transmitter such as an NFC transmitter, BLUETOOTH transmitter, ultrawideband transmitter, etc., which could transmit the transaction information, such as the merchant identifier 329, transaction identifier 346, transaction amount 349, etc., to the client device 313 when the client device 313 is in proximity to the merchant terminal 309.

When implemented as a virtual device, the merchant terminal 309 could be a component of an electronic commerce system, such as a website or web-based store-front for a merchant. In this context, the merchant terminal 309 could also be implemented as a server-side component of a dedicated application provided by the merchant and installed on the client device 313 that allows a user of the client device 313 to make purchases from a merchant as an alternative to using a website provided by the merchant. In these implementations, the merchant terminal 309 could cause a matrix bar code 106 to be presented on a webpage or a URL 206 to be presented within a user interface of a dedicated application. The matrix bar code 106 or URL 206 could include transaction information such as the merchant identifier 329, transaction identifier 346, transaction amount 349, etc.

A terminal application 353 could also be executed by the merchant terminal 309 to facilitate the operation of the merchant terminal 309. Accordingly, the terminal application 353 could be implemented in software (e.g., as firmware or an application installed on a physical merchant terminal 309) or hardware (e.g., as an application specific integrated circuit (ASIC)). In those implementations where the merchant terminal 309 is a virtual terminal, the terminal application 353 could be implemented as an application library, component, or standalone service to provide the functionality of a merchant terminal 309 to a web application or electronic commerce system.

As previously mentioned, various data can be stored by the merchant terminal 309. This information can include a merchant identifier 329, a transaction identifier 346, a transaction amount 349, a customer identifier 351, and potentially other information. The merchant identifier 329 identifies the merchant operating the merchant terminal 309. Individual transactions performed with the merchant terminal 309 can also be assigned a transaction identifier 346, which can be used to uniquely identify the transaction with respect to other transactions performed by the merchant. The transaction amount 349 can also be stored for individual transactions performed by the merchant.

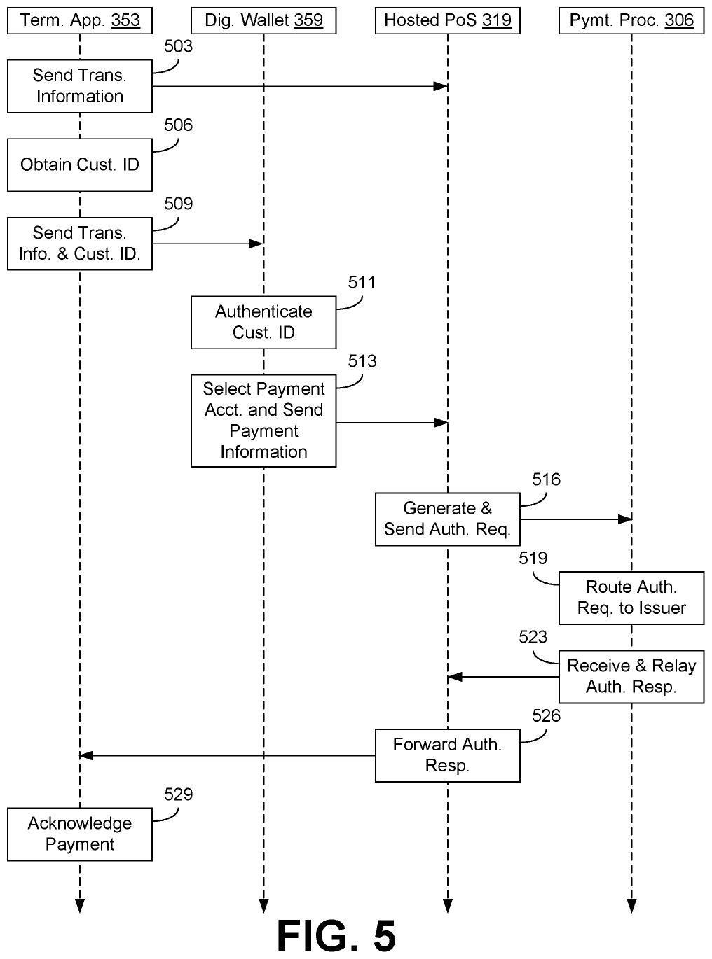

The customer identifier 351 can represent an identifier that uniquely identifies a customer with respect to other customers. Examples of customer identifiers 351 include biometric signatures (e.g., representing user faces, fingerprints, or other biometric data), user names, or combinations of user names and some other authenticating item of data (e.g., a password, personal identification number (PIN), one-time password, etc.). A customer identifier 351 can be collected and temporarily stored by the merchant terminal 309 in some implementations of the present disclosure, such as those depicted by FIG. 5.

The client device 313 is representative of any individual one of a plurality of client devices 313 that can be coupled to the network 316. The client device 313 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, portable game consoles, electronic book readers, and similar devices), media playback devices (e.g., media streaming devices, BluRay® players, digital video disc (DVD) players, set-top boxes, and similar devices), a videogame console, or other devices with like capability. The client device 313 can include one or more displays 356, such as liquid crystal displays (LCDs), gas plasma-based flat panel displays, organic light emitting diode (OLED) displays, electrophoretic ink (“E-ink”) displays, projectors, or other types of display devices. In some instances, the display 356 can be a component of the client device 313 or can be connected to the client device 313 through a wired or wireless connection.

The client device 313 can be configured to execute various applications such as a browser 103, digital wallet 359, or other client applications. The browser, 103, digital wallet 359, or other client applications could render a user interface 363 on the display 356, which could include user interface elements or other mechanisms to obtain user input.

The digital wallet 359 can be executed to facilitate or allow payment transactions to be made by an authorized user of the client device 313. Accordingly, the digital wallet 359 can be configured to store payment account data 366 related to individual payment instruments, methods or accounts. The digital wallet 359 can also be configured to transmit at least a portion of the payment account data 366 to third-parties, such as merchants, payment processors 306, the hosted point-of-sale service 319, etc., in order to initiate, facilitate, or complete a payment transaction. In some implementations, a digital wallet 359 can store information for multiple payment instruments and allow a user to select a payment instrument for use with a particular transaction. In other instances, the digital wallet 359 could be associated with a single payment instrument, such as a digital wallet 359 issued by a bank to facilitate payments using debit, credit, or charge cards issued by the bank. Examples of digital wallets 359 include ALIPAY®, APPLE PAY®, GOOGLE PAY®, SAMSUNG PAY®, and WECHAT PAY®, as well as mobile applications released by banks or other financial institutions, such as applications released by PAYPAL® or AMERICAN EXPRESS® for mobile devices.

Various types of information could be stored on the client device 313 to facilitate the operation of the digital wallet 359. For example, payment account data 366 could be stored on the client device 313 for use by the digital wallet 359 to initiate a payment on behalf of a user of the client device 313 using a payment account authorized, selected, or requested by the user. Examples of payment accounts could include payment card accounts, such as debit, credit, or charge card accounts. Accordingly, payment account data 366 could include information such as an account identifier 369, the name 373 of the account holder, a security code 376, an application transaction counter (ATC) 379, a cryptogram generating key 383, and an expiration date 386, as well as other information that can be used by future versions of the EMV standard or similar payment card security standards. In addition, one or more authorized user identifiers 389 can be stored on the client device 313. Information related to a transaction with a merchant, such as a merchant identifier 329, transaction identifier 346, and transaction amount 349, can also be stored at times on the client device 313.

The account identifier 369 represents a unique identifier for the payment card account stored on the client device 313, which uniquely identifies a payment card account with respect to other payment card accounts. The account identifier 369 can also be referred to as a transaction account number (TAN) or primary account number (PAN). Examples of account identifiers 369 include debit, credit, or charge card account numbers issued for individual debit, credit, or charge cards. However, other types of account identifiers 369 could be used as payment technologies and standards evolve.

The name 373 represents the name of the account holder, owner, or authorized user of the payment card account associated with or represented by the payment account data 366. The name 373 is often printed, embossed, or etched on the physical payment card issued to an individual.

The security code 376 represents any code that, when presented by a user as part of a transaction authorization request, indicates that the user is in physical possession of the payment card. The security code 376 often is represented as a three or four digit number. Examples of security codes 376 include the card security code (CSC), card verification data (CVD), card verification number (CVN), card verification value (CVV), card identification number (CID number), card verification code (CVC), etc. The security code 376 can be static or dynamic. Static security codes 376 remain constant so long as the respective payment card is valid, and can be reused for multiple transactions. For those payment cards that have a chip installed on them, such as EMV compliant payment cards, a dynamic security codes 376 can be generated as part of the authentication process for each transaction.

The application transaction counter (ATC) 379 represents an integer value that can be incremented for each transaction in which a payment card or payment card instrument participates. In the case of a digital wallet 359, the ATC 379 can be initialized when a payment card is first registered with or linked to the digital wallet 359. As the digital wallet 359 is used to initiate or authorize payments, the digital wallet 359 can increment the ATC 379 stored in associated with the payment account data 366.

The cryptogram generating key 383 can represent any cryptographic key that can be used for the purpose of generating a cryptogram used to authorize a transaction. One example of a cryptogram generating key 383 is an application cryptogram master key (MKAC), which is used by EMV compliant payment cards to generate a unique session key (SKAC) that can be used to create a cryptogram for each transaction. The session key (SKAC) can also be considered to be a cryptogram generating key 383 in some instances. However, other cryptographic keys could also be used as payment technologies and standards evolve.

The expiration date 386 can represent the date that the payment account represented by the payment account data 366 expires or is otherwise no longer valid. The expiration date 386 can typically be represented by the month and year of expiration. However, other date formats can also be used (e.g., day, month and year; year; etc.).

The authorized user identifier 389 can represent an identifier that identifies whether a user is authorized to use the client device 313 and/or the digital wallet 359. In some implementations, multiple users exist, and individual authorized user identifiers 389 can be linked or associated with payment account data 366 for individual payment accounts registered or enrolled with the digital wallet 359. In these implementations, such a linkage between individual authorized user identifiers 389 and payment account data 366 for individual payment accounts would allow for multiple users to use the digital wallet 359 of a client device 313, but be limited to using specific payment accounts that the users were previously authorized to use. Examples of authorized user identifiers 389 include biometric signatures (e.g., representing user faces, fingerprints, or other biometric data), user names, or combinations of user names and some other authenticating item of data (e.g., a password, personal identification number (PIN), one-time password, etc.).

FIG. 3 also depicts that the merchant terminal 309 can store payment account data 366 or a subset of payment account data 366 in some implementations. For example, in implementations where the merchant terminal 309 is implemented in software (e.g., as a virtual terminal, as a component of a web-based storefront rendered by the browser 103, or as a component of an electronic commerce application or dedicated shopping application), the merchant terminal 309 could store payment information to facilitate or expedite future payments. For example, a web-based storefront could store the account identifier 369, name 373, and expiration date 386 for a transaction account of a user to expedite payments for future transactions. The ATC 379 and the cryptogram generating key 383 could also be stored by the merchant terminal 309 in some instances. In these implementations, the payment account data 366 stored on the merchant terminal 309 could also include or be associated with a user identifier 393.

The user identifier 393 could represent a user account for a user of a web-based storefront, electronic commerce application, or dedicated shopping application. Accordingly, the user identifier 393 could represent any identifier that uniquely identifies a user with respect to other users. However, commonly used user identifiers 393 could include usernames, email addresses, etc. When a user logs into his or her user account to complete the checkout process, the merchant terminal 309 could retrieve the associated account identifier 369, name 373, and expiration date 386 for the transaction account of the user based at least in part on the user identifier 393. The merchant terminal 309 could then provide the associated account identifier 369, name 373, and expiration date 386 to the hosted point-of-sale service 319 when the user attempts to complete the transaction or payment. In some instances, the merchant terminal 309 could also be configured to provide the ATC 379 and the cryptogram generating key 383 to the hosted point-of-sale service 319.

Referring next to FIG. 4, shown is a sequence diagram that provides one example of the operation of the interactions between the various components of the network environment 300 of FIG. 3. As an alternative, the sequence diagram of FIG. 4 can be viewed as depicting an example of elements of one or more methods implemented within the network environment 300.

Beginning with block 403, the terminal application 353 causes the merchant terminal 309 to send transaction information to the hosted point-of-sale service 319. This transaction information can include a merchant identifier 329, a transaction amount 349, and a transaction identifier 346. The transaction information could be sent, for example, in response to a user checking out with a cashier using a physical merchant terminal 309 or a user initiating the checkout process on a merchant's website or within a dedicate shopping application provided by the merchant and installed on the user's client device 313. In some implementations, the transaction information sent by the terminal application 353 to the hosted point-of-sale service 319 could also include the account identifier 369, name 373, and expiration date 386 of a transaction account. In some instances, the terminal application 353 could also provide the ATC 379 and the cryptogram generating key 383 to the hosted point-of-sale service 319.

Then, at block 406, the terminal application 353 can cause the merchant terminal 309 to present the transaction information (e.g., merchant identifier 329, transaction amount 349, and transaction identifier 346) to the customer. This could be done using a variety of approaches as appropriate for any particular implementation.

For example, if the merchant terminal 309 were a physical merchant terminal 309, the terminal application 353 could cause the merchant terminal 309 to display a matrix bar code 106 on a display of the merchant terminal 309. If the merchant terminal 309 were implemented as a virtual merchant terminal 309 (e.g., as part of the checkout process for a website), the terminal application 353 could cause the website to display the matrix bar code 106 on a webpage within the user's browser 103. As previously discussed, the matrix bar code 106 could encode the relevant transaction information, which could be optically scanned using a camera installed on the client device 313 of the user. As another example, if the merchant terminal 309 were a physical merchant terminal 309, the terminal application 353 could cause the merchant terminal 309 to transmit the transaction information to a client device 313 using a wireless transmission, such as a near-field communication (NFC) transmission, BLUETOOTH transmission, ultrawideband transmission, etc. In another example of the merchant terminal 309 being operated as a virtual terminal, the terminal application 353 could cause a website or dedicated application to display a URL 206 that encodes the transaction information and, when selected or manipulated, causes the digital wallet 359 to open and passes the transaction information to the digital wallet 359. Other approaches can also be used as communication technology evolves.

Next at block 409, the digital wallet 359 obtains the transaction information presented by the terminal application 353. For example, if the terminal application 353 caused the merchant terminal 309 to render a matrix bar code 106, a user could use a camera installed on his or her client device 313 to scan the matrix bar code 106. The digital wallet 359 could then evaluate the matrix bar code 106 to obtain the merchant identifier 329, transaction amount 349, and transaction identifier 346 for the transaction, as well as other information that can be desired. Likewise, if the merchant terminal 309 initiates a wireless transmission such as an NFC transmission, BLUETOOTH transmission, ultrawideband transmission, etc. with the client device 313, the digital wallet 359 could prompt a user to accept the transmission. Once accepted, the digital wallet 359 could obtain the merchant identifier 329, transaction amount 349, and transaction identifier 346 for the transaction via the wireless transmission. In another example, if the terminal application 353 had cause the merchant terminal 309 to encode a URL 206 containing the transaction information, such as the merchant identifier 329, transaction amount 349, and transaction identifier 346 for the transaction, then the digital wallet 359 could parse the arguments of the URL to obtain the transaction information.

Moving on to block 413, the digital wallet 359 can authenticate the user of the client device 313 in order to determine whether the current user of the client device 313 is an authorized user of the digital wallet 359. This can be done, for example, in order to prevent a thief from making payments using a stolen client device 313. For example, the digital wallet 359 could prompt the user of the client device 313 to enter a password, personal identification number (PIN), or other secret. If the password or PIN entered by the user matches a stored password or PIN specified by an authorized user identifier 389, the digital wallet 359 could conclude that the current user of the client device 313 is an authorized user of the digital wallet 359. As another example, the digital wallet 359 could prompt the user to supply biometric information using a sensor installed on the client device 313. If the signature of the supplied biometric information matches a stored signature specified by an authorized user identifier 389, then digital wallet 359 could conclude that the current user of the client device 313 is an authorized user of the digital wallet 359. For instance, if a fingerprint captured by a camera or fingerprint reader installed on the client device 313 matched a previously stored fingerprint specified by an authorized user identifier 389, then the digital wallet 359 could conclude that the current user of the client device 313 is an authorized user of the digital wallet 359. As another example, if an image of the face of the user of the client device 313 captured using a camera of the client device 313 matched a previously stored facial image of an authorized as specified by an authorized user identifier 389, then the digital wallet 359 could conclude that the current user of the client device 313 is an authorized user of the digital wallet 359. In some implementations, the digital wallet 359 could use a combination of authentication mechanisms to authenticate the user, such as combining facial recognition or fingerprint matching with a user inputting a PIN or password.

Proceeding to block 416, the digital wallet 359 can prompt the user to confirm or authorize the transaction in response to authentication. For example, the digital wallet 359 could display information about the transaction, such as the identity of the merchant (possibly based on the merchant identifier 329) and the transaction amount 349. The user could then provide his or her approval of the transaction, such as by clicking a button to confirm approval.

The user could have multiple payment accounts registered, enrolled, or otherwise managed by the digital wallet 359. Accordingly, as part of the approval process as block 416, some implementations of the digital wallet 359 could also prompt the user to select a payment account from the multiple available payment accounts registered, enrolled, or otherwise managed by the digital wallet 359 to use for completing the transaction with the merchant. However, other implementations might not prompt the user to select a payment account (e.g., if the user only has one payment account registered, enrolled, or otherwise managed by the digital wallet 359).

Then, at block 419, the digital wallet 359 can send the payment account data 366 for the selected payment account to the hosted point-of-sale service 319. This can include the account identifier 369, name 373, security code 376, ATC 379, cryptogram generating key 383, expiration date 386, and other payment account data 366. In some implementations, the digital wallet 359 could generate and send a single use session key valid for authorizing a single transaction as the cryptogram generating key 383 (e.g., an EMV compliant session key derived from an EMV compliant Application Cryptogram Master Key (MKAC)). However, in other implementations, the digital wallet 359 could send the cryptogram generating key 383 itself (e.g., an EMV compliant MKAC), which could be used by the hosted point-of-sale service 319 to derive a single use session key valid for authorizing the transaction.

To send the payment account data 366, the digital wallet 359 could first encrypt the payment account data 366 prior to sending it to the hosted point-of-sale service 319 using a previously agreed upon cryptographic key (e.g., either a shared symmetric encryption key or the public key of a public-private key pair used by the hosted point-of-sale service 319). The digital wallet 359 can also send transaction information to the hosted point-of-sale service 319, such as the merchant identifier 329, transaction amount 349, and transaction identifier 346 for the transaction, so that the hosted point-of-sale service 319 can determine which transaction is to be processed using the payment account data 366 provided by the digital wallet 359.

Next at block 423, the hosted point-of-sale service 319 can receive the encrypted payment account data 366 and transaction data from the digital wallet 359 and generate an authorization request for the transaction in response. The hosted point-of-sale service 319 can then determine whether the merchant has requested that the transaction be processed, for example, by confirming that the merchant identifier 329, transaction identifier 346, and transaction amount 349 supplied by the digital wallet 359 match the merchant identifier 329, transaction identifier 346, and transaction amount 349 provided by the terminal application 353 at block 403. If the transaction information provided by the terminal application 353 matches the transaction information provided by the digital wallet 359, the hosted point-of-sale service 319 can generate an authorization request for the transaction using the payment account data 366 received from the digital wallet 359. The authorization request can include a cryptogram generated by the hosted point-of-sale service 319 as well as transaction information such as the merchant identifier 329, transaction identifier 346, and transaction amount 349. In many implementations, the cryptogram can be compliant with the EMV standard for online transactions, such as an Authorization Request Cryptogram (ARQC). Accordingly, the authorization request could be formatted to comply with the ISO 8583 1100 standard, or similar future standards. Once the authorization request is created, the hosted point-of-sale service 319 can send the authorization request to the payment processor 306 of the merchant, as identified by the payment processor identifier 343 stored in the merchant profile 326.

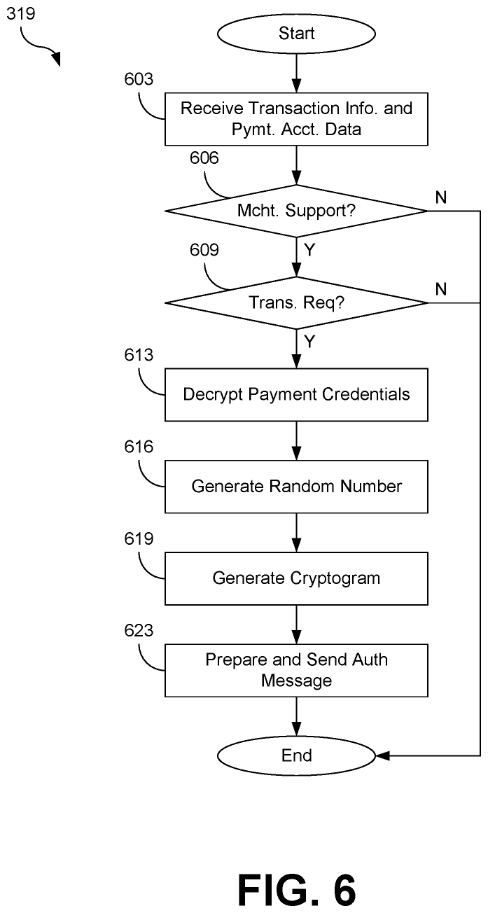

In contrast to EMV compliant transactions card-present transactions, the hosted point-of-sale service 319 can skip many of the steps specified by the EMV standard. For example, because the user has already been authenticated by the digital wallet 359, a personal identification number does not need to be requested. As another example, an Application Interchange Profile (AIP) and an Application File Locator (AFL) do not need to be requested by the hosted point-of-sale service 319 because the hosted point-of-sale service 319 generates the EMV compliant cryptogram on behalf of the digital wallet 359, and the hosted point-of-sale service 319 is aware of its own capabilities. A more detailed description of the process performed at block 423 is described in the discussion of FIG. 6.

Moving on to block 426, the payment processor 306 can route the authorization request to the issuer of the payment card account. The issuer can then evaluate the authorization request and approve or deny the transaction. If the authorization request included an ARQC (e.g., because it complied with the EMV standard), the issuer could generate an authorization response cryptogram (ARPC) and provided it to the payment processor 306 in response.

Proceeding to block 429, the payment processor 306 can receive the authorization response, including potentially the ARPC, from the issuer. The payment processor 306 can then relay the authorization response to the hosted point-of-sale service 319 for further processing.

Then, at block 433, the hosted point-of-sale service 319 can extract the relevant information from the authorization response (e.g., transaction identifier 346, transaction amount 349, authorization approval or denial, etc.) and forward it on to the terminal application 353. However, in some implementations, the hosted point-of-sale service 319 could forward the entire authorization response to the terminal application 353. In these implementations, the terminal application would need to evaluate the authorization response for relevant information. The hosted point-of-sale service 319 could also verify the ARPC included in the authorization response at this point before forwarding or relaying any information on to the terminal application 353.

Subsequently, at block 436, the terminal application 353 receives the authorization information from the hosted point-of-sale service 319. If the transaction were authorized, the terminal application 353 can cause the merchant terminal 309 to take an appropriate action acknowledging payment (e.g., print a receipt, display an order confirmation on a screen of the merchant terminal 309 or client device 313, etc.). Similarly, if the transaction were declined, the terminal application 353 could cause the merchant terminal 309 to take an appropriate action alerting the user that the payment had been declined.

Referring next to FIG. 5, shown is a sequence diagram that provides one example of the operation of the interactions between the various components of the network environment 300 of FIG. 3. Although discussed separately from the sequence diagram of FIG. 4, it should be noted that any one or more of the interactions described or discussed in FIG. 5 could implemented in combination with any one or more of the interactions described or discussed in FIG. 5. As an alternative, the sequence diagram of FIG. 5 can be viewed as depicting an example of elements of one or more methods implemented within the network environment 300.

Beginning with block 503, the terminal application 353 causes the merchant terminal 309 to send transaction information to the hosted point-of-sale service 319. This transaction information can include a merchant identifier 329, a transaction amount 349, and a transaction identifier 346. The transaction information could be sent, for example, in response to a user checking out with a cashier using a physical merchant terminal 309 or a user initiating the checkout process on a merchant's website or within a dedicate shopping application provided by the merchant and installed on the user's client device 313. In some implementations, the transaction information sent by the terminal application to the hosted point-of-sale service 319 could also include the account identifier 369, name 373, and expiration date 386 of a transaction account. In some instances, the terminal application 353 could also provide the ATC 379 and the cryptogram generating key 383 to the hosted point-of-sale service 319.

Next, at block 506, the terminal application 353 can obtain a customer identifier 351 that represents an authorized user of the digital wallet 359. For example, the terminal application 353 could cause the merchant terminal 309 to request that the customer submit username and a password, PIN, or a one-time-password through a user interface of the merchant terminal 309. As another example, the terminal application 353 could cause the merchant terminal 309 to use an integrated camera, fingerprint scanner, or other biometric sensor to obtain a biometric signature of the user, such as an image of the face of the user for facial recognition or an image of a fingerprint for fingerprint recognition. Other approaches can also be used as desired for other implementations of the present disclosure.

Moving on to block 509, the terminal application 353 sends the transaction information and the customer identifier 351 to the digital wallet 359. This could be done using a variety of approaches as appropriate for any particular implementation. For example, if the merchant terminal 309 were a physical merchant terminal 309, the terminal application 353 could cause the merchant terminal 309 to display a matrix bar code 106 on a display of the merchant terminal 309. If the merchant terminal 309 were implemented as a virtual merchant terminal 309 (e.g., as part of the checkout process for a website), the terminal application 353 could cause the website to display the matrix bar code 106 on a webpage within the user's browser 103. As previously discussed, the matrix bar code 106 could encode the relevant transaction information, such as the merchant identifier 329, transaction amount 349, and a transaction identifier 346, as well as the customer identifier 351 obtained at block 506. The matrix bar code 106 (e.g., matrix bar code 106a or 106b) could then be optically scanned using a camera installed on the client device 313 of the user. As another example, if the merchant terminal 309 were a physical merchant terminal 309, the terminal application 353 could cause the merchant terminal 309 to transmit the transaction information and customer identifier to a client device 313 using a wireless transmission such as a near-field communication (NFC) transmission, a BLUETOOTH transmission, an ultrawideband transmission, etc. In another example of the merchant terminal 309 being operated as a virtual terminal, the terminal application 353 could cause a website or dedicated application to display a URL 206 that encodes the transaction information and customer identifier. When the URL 206 is later selected or manipulated, the URL 206 could cause the digital wallet 359 to open and retrieve the transaction information and customer identifier 351 from the URL. Other approaches can also be used as communication technology evolves.

Referring to block 511, the digital wallet 359 could authenticate the customer identifier 351 provided by the terminal application 353. For example, the digital wallet 359 could compare the received customer identifier 351 with a locally stored authorized user identifier 389. If the received customer identifier 351 matches the stored authorized user identifier 389, then the digital wallet 359 could determine that an authorized user initiated the transaction with the merchant operating the merchant terminal 309 that is executing the terminal application 353.

Then, at block 513, the digital wallet 359 can prompt the user to select a payment account for paying the merchant and send the payment account data 366 for the selected payment account to the hosted point-of-sale service 319. For example, the user could have multiple payment accounts registered, enrolled, or otherwise managed by the digital wallet 359. Accordingly, some implementations of the digital wallet 359 could prompt the user to select a payment account from the multiple available payment accounts registered, enrolled, or otherwise managed by the digital wallet 359 to use for completing the transaction with the merchant. However, other implementations might not prompt the user to select a payment account (e.g., if the user only has one payment account registered, enrolled, or otherwise managed by the digital wallet 359).

Once a payment account is selected, then the respective payment account data 366 can be sent by the digital wallet 359 to the hosted point-of-sale service 319. This can include the account identifier 369, name 373, security code 376, ATC 379, cryptogram generating key 383, expiration date 386, and other payment account data 366. In some implementations, the digital wallet 359 could generate and send a single use session key valid for authorizing a single transaction as the cryptogram generating key 383 (e.g., an EMV compliant session key derived from an EMV compliant Application Cryptogram Master Key (MKAC)). However, in other implementations, the digital wallet 359 could send the cryptogram generating key 383 itself (e.g., an EMV compliant MKAC), which could be used by the hosted point-of-sale service 319 to derive a single use session key valid for authorizing the transaction.

To send the payment account data 366, the digital wallet 359 could first encrypt the payment account data 366 prior to sending it to the hosted point-of-sale service 319 using a previously agreed upon cryptographic key (e.g., either a shared symmetric encryption key or the public key of a public-private key pair used by the hosted point-of-sale service 319). The digital wallet 359 can also send transaction information to the hosted point-of-sale service 319, such as the merchant identifier 329, transaction amount 349, and transaction identifier 346 for the transaction, so that the hosted point-of-sale service 319 can determine which transaction is to be processed using the payment account data 366 provided by the digital wallet 359.

Proceeding to at block 516, the hosted point-of-sale service 319 can receive the encrypted payment account data 366 and transaction data from the digital wallet 359 and generate an authorization request for the transaction in response. The hosted point-of-sale service 319 can then determine whether the merchant has requested that the transaction be processed, for example, by confirming that the merchant identifier 329, transaction identifier 346, and transaction amount 349 supplied by the digital wallet 359 match the merchant identifier 329, transaction identifier 346, and transaction amount 349 provided by the terminal application 353 at block 403. If the transaction information provided by the terminal application 353 matches the transaction information provided by the digital wallet 359, the hosted point-of-sale service 319 can generate an authorization request for the transaction using the payment account data 366 received from the digital wallet 359. The authorization request can include a cryptogram generated by the hosted point-of-sale service 319 as well as transaction information such as the merchant identifier 329, transaction identifier 346, and transaction amount 349. In many implementations, the cryptogram can be compliant with the EMV standard for online transactions, such as an Authorization Request Cryptogram (ARQC). Accordingly, the authorization request could be formatted to comply with the ISO 8583 1100 standard, or similar future standards. Once the authorization request is created, the hosted point-of-sale service 319 can send the authorization request to the payment processor 306 of the merchant, as identified by the payment processor identifier 343 stored in the merchant profile 326.

In contrast to EMV compliant transactions card-present transactions, the hosted point-of-sale service 319 can skip many of the steps specified by the EMV standard. For example, because the user has already been authenticated by the digital wallet 359, a personal identification number does not need to be requested. As another example, an Application Interchange Profile (AIP) and an Application File Locator (AFL) do not need to be requested by the hosted point-of-sale service 319 because the hosted point-of-sale service 319 generates the EMV compliant cryptogram on behalf of the digital wallet 359, and the hosted point-of-sale service 319 is aware of its own capabilities. A more detailed description of the process performed at block 516 is described in the discussion of FIG. 6.

Next at block 519, the payment processor 306 can route the authorization request to the issuer of the payment card account. The issuer can then evaluate the authorization request and approve or deny the transaction. If the authorization request included an ARQC (e.g., because it complied with the EMV standard), the issuer could generate an authorization response cryptogram (ARPC) and provided it to the payment processor 306 in response.

Proceeding to block 523, the payment processor 306 can receive the authorization response, including potentially the ARPC, from the issuer. The payment processor 306 can then relay the authorization response to the hosted point-of-sale service 319 for further processing.

Then, at block 526, the hosted point-of-sale service 319 can extract the relevant information from the authorization response (e.g., transaction identifier 346, transaction amount 349, authorization approval or denial, etc.) and forward it on to the terminal application 353. However, in some implementations, the hosted point-of-sale service 319 could forward the entire authorization response to the terminal application 353. In these implementations, the terminal application would need to evaluate the authorization response for relevant information. The hosted point-of-sale service 319 could also verify the ARPC included in the authorization response at this point before forwarding or relaying any information on to the terminal application 353.

Subsequently, at block 529, the terminal application 353 receives the authorization information from the hosted point-of-sale service 319. If the transaction were authorized, the terminal application 353 can cause the merchant terminal 309 to take an appropriate action acknowledging payment (e.g., print a receipt, display an order confirmation on a screen of the merchant terminal 309 or client device 313, etc.). Similarly, if the transaction were declined, the terminal application 353 could cause the merchant terminal 309 to take an appropriate action alerting the user that the payment had been declined.

Referring next to FIG. 6, shown is a flowchart that provides one example of the operation of a portion of the hosted point-of-sale service 319, such as the portion previously described at block 423 in the sequence diagram of FIG. 4 and the portion previously described at block 516 in the sequence diagram of FIG. 5. Accordingly, any one or more of the operations of FIG. 6 can be combined with any one or more of the operations of FIG. 4 or FIG. 5 according to the various embodiments of the present disclosure. The flowchart of FIG. 6 provides merely an example of the many different types of functional arrangements that can be employed to implement the operation of the depicted portion of the hosted point-of-sale service 319. As an alternative, the flowchart of FIG. 6 can be viewed as depicting an example of elements of a method implemented within the network environment 300.

Beginning with block 603, the hosted point-of-sale service 319 can receive payment account data 366 and transaction information, such as a merchant identifier 329, a transaction identifier 346, and/or a transaction amount 349. In some implementations, the payment account data 366 and the transaction information could be received from a digital wallet 359 executing on a client device 313. However, in some instances, a portion of the payment account data 366 could come from another source than the client device 313, such as a merchant computing system that has previously stored payment account data 366 for a user. This could occur when a merchant's electronic commerce application, dedicated shopping application, or web-based storefront saves payment account data 366 for use in future transactions. In other implementations, the transaction information could be received separately from another source than the client device 313, such as the terminal application 353. As previously discussed, the payment account data 366 provided by the digital wallet 359 of the client device 313 can include an account identifier 369, a name 373 of the account holder, a security code 376, an ATC 379, a cryptogram generating key 383, and an expiration date 386. In some implementations, the cryptogram generating key 383 received from the digital wallet 359 could be a single use session key valid for authorizing a single transaction (e.g., an EMV compliant session key derived from an EMV compliant Application Cryptogram Master Key (MKAC)). In other instances, the cryptogram generating key 383 received from the digital wallet 359 can be a master key (e.g., an EMV compliant MKAC), which could be used by the hosted point-of-sale service 319 to derive a single use session key valid for authorizing the transaction.

In some implementations, the payment account data 366 can be received in encrypted or obfuscated form for security purposes. This information can be received by the hosted point-of-sale service 319 in response to a customer attempting to pay a merchant using his or her digital wallet 359.

Then, at block 606, the hosted point-of-sale service 319 can determine whether the merchant whom the user of the digital wallet 359 is attempting to pay is supported by the hosted point-of-sale service 319. This can be done by searching for a merchant profile 326 with a merchant identifier 329 that matches the merchant identifier 329 received from the digital wallet 359. If no matching merchant profile 326 is identified, then the hosted point-of-sale service 319 can determine that the merchant is unsupported by the hosted point-of-sale service 319 (e.g., because the merchant has not yet registered or enrolled with the hosted point-of-sale service 319). In response, the process can end and the hosted point-of-sale service 319 can return an error message. However, if a matching merchant profile 326 is identified, then the process can proceed to block 609.

Next, at block 609, the hosted point-of-sale service 319 can determine whether the transaction that the digital wallet 359 is attempting to complete has been previously requested to be authorized. Accordingly, the hosted point-of-sale service 319 can use the transaction identifier 346 provided by the digital wallet 359 to see if matching transaction data has been previously provided by the terminal application 353 of a merchant terminal 309. If a match is identified, then the process can proceed to block 613. If no match is identified, then the process can end and the hosted point-of-sale service 319 can return an error message indicating that the merchant has not requested authorization of the transaction.

Moving on to block 613, the hosted point-of-sale service 319 can decrypt the payment account data 366 previously received at block 603. For example, the hosted point-of-sale service 319 could use a respective private key of a public-private key pair to decrypt the payment account data 366. As another example, the hosted point-of-sale service 319 could use a previously shared symmetric encryption key to decrypt the encrypted payment account data 366 previously received at block 603.

Proceeding to block 616, the hosted point-of-sale service 319 can generate a random number. The random number can be used, for example, as a seed value for generating a subsequent cryptogram as part of an authorization request for the transaction. In implementations that generate cryptograms and authorization requests that comply with a version of the EMV standard, the random number generated at block 616 could be the Unpredictable Number specified by the EMV standard.

Next at block 619, the hosted point-of-sale service 319 can generate a cryptogram for use as part of an authorization request to pay the merchant using the payment account specified by the payment account data 366. In the following paragraphs, a description is provided as to how an Authorization Request Cryptogram (ARQC) that complies with the EMV standard could be generated. However, similar principals could be applied for use with other card security standards or for other authorization cryptograms specified by the EMV standard.

To generate an ARQC, the hosted point-of-sale service 319 can first determine the identity of the payment network that will be used to relay the authorization request to the issuer. This can be done, for example, by evaluating the account identifier 369 received from the digital wallet 359. If the account identifier 369 represented a credit card number or charge card number with a beginning digit of “3,” then the hosted point-of-sale service 319 could determine that the AMERICAN EXPRESS® payment network is to be used, and that an AMERICAN EXPRESS specific payment application 323 should be used to generate the cryptogram. Similarly, if the account identifier 369 represented a credit card number or charge card number with a beginning digit of “4,” then the hosted point-of-sale service 319 could determine that the VISA® payment network is to be used, and that a VISA specific payment application 323 should be used to generate the cryptogram. Likewise, if the account identifier 369 represented a credit card number or charge card number with a beginning digit of “5,” then the hosted point-of-sale service 319 could determine that the MASTERCARD® payment network is to be used, and that a MASTERCARD specific payment application 323 should be used to generate the cryptogram.

Once an appropriate payment application 323 is selected, it can be executed to prepare the input data needed to generate an appropriate ARQC for the identified payment network. For example, the payment application 323 could select and concatenate one or more of the account identifier 369, the random number generated at block 616, the ATC 379, the transaction currency 333, the transaction amount 349, the merchant location 336, transaction identifier 346, date of the transaction, type of the transaction, and/or other information specified by a current or future version of the EMV standard.

The output of the payment application 323 can then be encrypted using the cryptogram generating key 383 using a variety of approaches to create the ARQC, such as by passing the output of the payment application 323 through an application cryptogram generation algorithm used in some versions of the EMV standard. For example, if the cryptogram generating key 383 received from the digital wallet 359 at block 603 were an EMV compliant Application Cryptogram Master Key (MKAC), then the hosted point-of-sale service 319 can generate a single use application cryptogram session key (SKAC) using the MKAC and the ATC 379 provided by the digital wallet 359. The SKAC could then be used to encrypt the output of the payment application 323, thereby creating the ARQC. In other implementations, the cryptogram generating key 383 could be the SKAC (e.g., because the digital wallet 359 used the ATC 379 and the MKAC to generate the SKAC for use as the cryptogram generating key 383). In these implementations, the hosted point-of-sale service 319 can use the cryptogram generating key 383 to directly encrypt the output of the payment application 323 in order to generate the ARQC.

Subsequently, at block 623, the hosted point-of-sale service 319 can prepare the authorization request and send it to the payment processor 306. To generate the authorization request, the hosted point-of-sale service 319 can include the cryptogram generated at block 619 (e.g., an ARQC if the authorization request is an EMV compliant authorization request) and other information that can be required by the issuer to authorize the transaction. This additional information could include the account identifier 369, transaction identifier 346, merchant identifier 329, transaction amount 349, and/or other information that the issuer can specific in order to evaluate and authorize the transaction. This information can then be included in a message, such as an authorization request that complies with the ISO 8583 1100 standard, or similar future standards, which can then be sent to the payment processor 306.

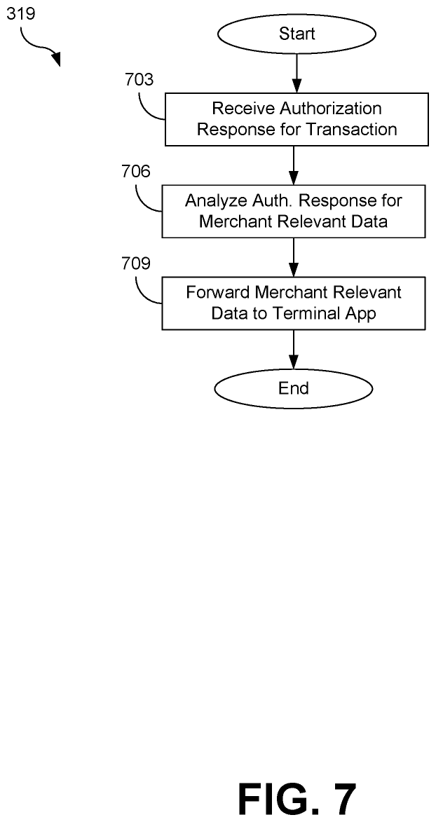

Referring next to FIG. 7, shown is a flowchart that provides one example of the operation of a portion of the hosted point-of-sale service 319, such as the portion previously described at block 423 in the sequence diagram of FIG. 4 and the portion previously described at block 526 in the sequence diagram of FIG. 5. Accordingly, any one or more of the operations of FIG. 7 can be combined with any one or more of the operations of any of FIGS. 4-6 according to the various embodiments of the present disclosure. The flowchart of FIG. 7 provides merely an example of the many different types of functional arrangements that can be employed to implement the operation of the depicted portion of the hosted point-of-sale service 319. As an alternative, the flowchart of FIG. 7 can be viewed as depicting an example of elements of a method implemented within the network environment 300.

Beginning with block 703, the hosted point-of-sale service 319 can receive an authorization response from the payment processor 306. The authorization response, as noted previously in the discussions of FIG. 4 and FIG. 5, could have been generated by an issuer and provided to the payment processor 306. The payment processor 306 could have then relayed the response to the hosted point-of-sale service 319. In some implementations, the authorization response could also be formatted to comply with the ISO 8583 1100 standard, or similar future standards.

Next at block 706, the hosted point-of-sale service 319 can analyze the authorization response for transaction data that would be relevant to the merchant operating the merchant terminal 309 and terminal application 353. Data could be specified as relevant by the merchant (e.g., as a setting stored within the merchant profile 326 of the merchant), or it could be defined as part of an industry standard or regulatory or legal rule. Examples of data that might considered to be relevant to the merchant include the transaction identifier 346, the transaction amount 349, the customer identifier 351 or account identifier 369 (either of which can be masked), whether the transaction was approved or denied, etc.

As part of the analysis performed at block 706, the hosted point-of-sale service 319 could also verify the integrity and/or authenticity of the authorization response. For example, if the authorization response complies with a version of the EMV standard, it could include an authorization response cryptogram (ARPC). Therefore, the hosted point-of-sale service 319 could evaluate an included ARPC to determine whether the response is a valid authorization response prior to analyzing the authorization response for transaction data that would be relevant to the merchant or moving on to block 709.

Subsequently at block 709, the hosted point-of-sale service 319 can forward the relevant data identified at block 706 to the terminal application 353 of the merchant terminal 309. This could be done in order to let the terminal application 353 know whether the transaction was authorized or declined, and allow the terminal application 353 to store a record of the transaction, provide a confirmation to the customer, and/or complete the purchase or checkout process.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Y; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a merchant identifier and a transaction amount for a transaction from a merchant terminal;
receive the merchant identifier and encrypted payment account data for the transaction;
decrypt the encrypted payment account data to generate payment account data;
generate an authorization request for the transaction based at least in part on the merchant identifier, the transaction amount, and the payment account data;
send the authorization request to a payment processor, the payment processor being configured to route the authorization request to an authorizing entity via a payment network;
receive an authorization response from the authorizing entity via the payment processor; and
forward the contents of the authorization response to the merchant terminal.

2. The system of claim 1, wherein the machine-readable instructions that cause the computing device to generate the authorization request for the transaction, when executed by the processor, further cause the computing device to at least:
generate an authorization request cryptogram; and
include the authorization request cryptogram in the authorization request.

3. The system of claim 2, wherein:
the encrypted payment account data include a cryptogram generating key and an application transaction counter (ATC) value; and
the authorization request cryptogram is generated based at least in part on the ATC value and the cryptogram generating key.

4. The system of claim 2, wherein the machine-readable instructions, when executed by the processor, further cause the computing device to at least:
identify the payment network to be used for the transaction from a plurality of supported payment networks; and
wherein the authorization request cryptogram is generated based at least in part on an identification of the payment network.

5. The system of claim 1, wherein the machine-readable instructions further cause the computing device to at least:
receive a transaction identifier for the transaction from the merchant terminal in conjunction with the merchant identifier and the transaction amount;
receive the transaction identifier for the transaction from the client device in conjunction with the merchant identifier and the encrypted payment account data;
link the transaction amount, merchant identifier, and the encrypted payment account data to the transaction based at least in part on the transaction identifier; and
wherein the authorization request for the transaction is generated in response to the transaction amount, merchant identifier, and the encrypted payment account data being linked.

6. The system of claim 1, wherein the machine-readable instructions that cause the computing device to forward the contents of the authorization response on to the merchant terminal, when executed by the computing device, further cause the computing device to at least:
evaluate the authorization response received from the authorizing entity via the payment processor for a subset of data contained in the authorization response; and
forward the subset of the data contained in the authorization response to the merchant terminal.

7. The system of claim 2, wherein the machine-readable instructions that cause the computing device to generate the authorization request cryptogram, when executed by the processor, further cause the computing device to at least:
create a derived cryptogram generating key from a master cryptogram generating key; and
generate the authorization request cryptogram using the derived cryptogram generating key.

8. A computer-implemented method, comprising:
receiving a merchant identifier and a transaction amount for a transaction from a merchant terminal;
receiving the merchant identifier and encrypted payment account data for the transaction;
decrypting the encrypted payment account data to generate payment account data;
generating an authorization request for the transaction based at least in part on the merchant identifier, the transaction amount, and the payment account data;
sending the authorization request to a payment processor, the payment processor being configured to route the authorization request to an authorizing entity via a payment network;
receiving an authorization response from the authorizing entity via the payment processor; and
forwarding the contents of the authorization response to the merchant terminal.

9. The computer-implemented method of claim 8, wherein generating the authorization request for the transaction further comprises:
generating an authorization request cryptogram; and
including the authorization request cryptogram in the authorization request.

10. The computer-implemented method of claim 9, wherein:
the encrypted payment account data include a cryptogram generating key and an application transaction counter (ATC) value; and
the authorization request cryptogram is generated based at least in part on the ATC value and the cryptogram generating key.

11. The computer-implemented method of claim 8, further comprising:
identifying the payment network to be used for the transaction from a plurality of supported payment networks; and
wherein the authorization request cryptogram is generated based at least in part on an identification of the payment network.

12. The computer-implemented method of claim 8, further comprising:
receiving a transaction identifier for the transaction from the merchant terminal in conjunction with the merchant identifier and the transaction amount;
receiving the transaction identifier for the transaction from the client device in conjunction with the merchant identifier and the encrypted payment account data;
linking the transaction amount, merchant identifier, and the encrypted payment account data to the transaction based at least in part on the transaction identifier; and
wherein the authorization request for the transaction is generated in response to the transaction amount, merchant identifier, and the encrypted payment account data being linked.

13. The computer-implemented method of claim 8, further comprising:
verifying an authorization response cryptogram included in the authorization response; and
wherein forwarding the contents of the authorization response to the merchant terminal occurs in response to verifying the authorization response cryptogram.

14. The computer-implemented method of claim 8, wherein forwarding the contents of the authorization response on to the merchant terminal further comprises:
evaluating the authorization response received from the authorizing entity via the payment processor for a subset of data contained in the authorization response; and
forwarding the subset of the data contained in the authorization response to the merchant terminal.

15. A non-transitory, computer-readable medium, comprising machine-readable instructions that, when executed by a processor of a computing device, cause the computing device to at least:
obtain a merchant identifier;
obtain a transaction identifier for a transaction;
authenticate a user of the computing device;
obtain a consent to the transaction; and
in response to authentication of the user of the computing device and obtaining the consent to the transaction, send payment account data, the merchant identifier, and the transaction identifier to a hosted point-of-sale service.

16. The non-transitory, computer-readable medium of claim 15, wherein the machine-readable instructions that cause the computing device to obtain the merchant identifier, when executed by the computing device, cause the computing device to at least:
capture an image of a two-dimensional barcode that encodes the merchant identifier; and
decode the two-dimensional barcode to obtain the merchant identifier.

17. The non-transitory, computer-readable medium of claim 15, wherein the machine-readable instructions that cause the computing device to obtain the merchant identifier, when executed by the computing device, cause the computing device to at least:
analyze one or more arguments provided to the machine-readable instructions when execution of the machine-readable instructions is initiated; and
determine the merchant identifier from the one or more arguments.

18. The non-transitory, computer-readable medium of claim 15, wherein the machine-readable instructions that cause the computing device to authenticate the user of the computing device further cause the computing device to at least:
present a prompt for a biometric identifier;
obtain the biometric identifier from a biometric sensor; and
determine that the biometric identifier provided to the computing device matches a stored biometric identifier of the user of the computing device.

19. The non-transitory, computer-readable medium of claim 15, wherein the payment account data comprises a master cryptogram generating key.

20. The non-transitory, computer-readable medium of claim 15, wherein the machine-readable instructions, when executed by the processor, further cause the computing device to at least:
generate a single use session cryptogram generating key based at least in part on a value of an application transaction counter (ATC) stored in a memory of the computing device; and
include the single use session cryptogram generating key in the payment account data.
